(19) United States
(12) Patent Application Publication
(10) Pub. No.: US 2022/0032741 A1
(43) Pub. Date: Feb. 3, 2022

(54) LAMINATED PANE WITH INTEGRATED ELECTRICAL ATTACHMENT PART

(71) Applicant: SAINT-GOBAIN GLASS FRANCE, COURBEVOIE (FR)

(72) Inventors: Li-Ya YEH, Geilenkirchen (DE); Jérémy PERRIN, Bioncourt (FR); Tobias NIELSEN, Köln (DE)

(21) Appl. No.: 16/766,522

(22) PCT Filed: Nov. 23, 2018
(86) PCT No.: PCT/EP2018/082327

§ 371 Date: Oct. 13, 2021

(30) Foreign Application Priority Data
Nov. 30, 2017 (EP) 17204559.3

(51) Int. Cl. B60J 1/00; B60J 1/02; B60J 1/18; B60J 1/08; B60K 35/00; B60J 9/00; B23K 26/402; B23K 26/0622; B32B 17/10; B32B 3/30

(52) U.S. Cl. CPC B60J 1/001; B60J 1/02; B60J 1/18; B60J 1/08; B60K 35/00; B60J 9/00; B23K 26/382; B23K 26/0624; B32B 17/10036; B32B 3/30; B32B 17/10293; B32B 17/10761; B23K 26/402

(57) ABSTRACT

A laminated pane having at least one integrated electrical attachment part, includes an inner pane having an inner side and an outer side, an outer pane having an inner side and an outer side, a thermoplastic intermediate layer, which joins the inner side of the outer pane and the inner side of the inner pane to one another, and at least one recess in the inner pane and/or the outer pane, wherein the electrical attachment part is inserted into the recess and is situated completely within the laminated pane, the laminated pane is a vehicle laminated pane having a three-dimensional bend, and the recess is introduced into the inner pane and/or the outer pane by laser processes.

The invention relates to a laminated pane comprising an electrically controllable attachment part embedded in a recess, a method for producing the laminated pane, and the use of the laminated pane as a motor vehicle pane.

Modern glazing systems are equipped with a variety of electrically controllable attachment parts, such as sensors, detectors, receiving or lighting units. Examples of such attachment parts are, in particular in the automotive sector, camera systems, rain sensors, antennas, and decorative or functional lighting elements. With the growing popularity of various assistance systems, the number of electrically controllable attachment parts in motor vehicles is also increasing. Due to their sensitivity, these must be protected against weather influences and are usually located behind the windshield of the vehicle in the passenger compartment.

EP 2 462 007 B1 describes a laminated pane with an optically transparent sensor field and a sensor mounted in the region of the sensor field. The sensor is situated within an encapsulation that protrudes into the passenger compartment of a motor vehicle. This encapsulation is visible in the passenger compartment as an elevation on the pane and and is perceived by the driver as possibly distracting and restricting the field of vision.

Depending on the type and size of the sensors required, they can also be introduced into the laminate of the laminated pane. Known, for example, from WO 2017/097536, is a light sensor whose photodiode is laminated into a thermoplastic intermediate layer that joins the outer pane and the inner pane of the laminated pane. However, this is possible only for very small components.

The problems of space-saving and visually inconspicuous integration of electrical components in laminated panes relate not only to sensors but also to functional or decorative lighting elements. For the colored illumination of symbols on panes, it is customary to introduce the symbols to be displayed into the pane using material removing processes, for example, laser patterning, and to mount light sources on the nearest edge of the pane. The light rays are coupled in via the edge of the glass pane, while out-coupling of the light takes place in the abrasively treated regions of the pane. The selective out-coupling of the light causes lighting of these regions in the form of the symbols or characters introduced, as shown, for example, in DE 20 2006 006 051 U1 with reference to a vehicle rear window with an illuminated warning symbol. Coupling light in via the edge of the glazing greatly restricts the possibilities for positioning the light sources since they can only be arranged along the relevant glazing edge.

In the architectural glazing sector, solutions for improving the space-saving integration of components such as lighting means are already known. WO 2004 080712 A1 discloses laminated panes in which one of the individual panes of the laminated pane has an opening into which a lighting means is inserted. The opening is created using mechanical methods such as drilling or milling. Such methods provide sufficient product quality in the case of flat panes with the thicknesses customary in the architectural glazing sector. In particular, with more complex geometries of an opening, curved panes, and lower pane thicknesses, such mechanical methods yield only inadequate results

WO 2004 106056 A1 discloses a laminated pane, in whose intermediate layer lighting means, for example, in the form of strip shaped LED elements, are inserted. Blind holes for accommodating the lighting means can be provided in one of the panes. The applications described in WO 2004 106056 A1 are in the area of planar decorative glazings.

DE 2014642 deals with improved antenna conductors in automotive glazings, with the objective of reducing interference. It was found that a minimum distance of 5 cm between electrical connection points of the antenna conductor and the metallic opening in the car body into which an automotive window is inserted is advantageous. In one possible embodiment, a drilled hole with such a minimum distance from the window surround is provided in the inner pane of a laminated glass pane. An electrical connection element is provided in this hole and the electrical connection is routed out.

WO 2007 009973 A1 and WO 2007 009974 A1 describe capacitive rain sensors for use in vehicle windshields that are introduced into the intermediate layer of a laminated pane introduced.

The object of the present invention is to provide a laminated pane having an electrically switchable attachment part, wherein the attachment part is integrated into the laminated pane in a space-saving and visually inconspicuous manner. Moreover, the object of the invention is to make available a method for producing such a laminated pane.

The object of the present invention is accomplished according to the invention by a laminated pane with an integrated electrical attachment part in accordance with the independent claim 1. Preferred embodiments are apparent from the dependent claims.

The laminated pane according to the invention having at least one integrated electrical attachment part comprises at least one inner pane and one outer pane that are laminated together via a thermoplastic intermediate layer. The laminated pane is a vehicle laminated pane with three-dimensional bending. The inner pane and the outer pane have in each case an inner side and an outer side that run substantially parallel to one another. The thermoplastic intermediate layer bonds the inner side of the inner pane and the inner side of the outer pane. The inner pane and/or the outer pane has at least one recess, in which the electrical attachment part is embedded. The electrical attachment part is situated completely within the laminated pane and protrudes in no dimension beyond the laminated pane. In other words, the electrical attachment part is situated completely between the outer side of the inner pane and the outer side of the outer pane . The recess is introduced into the inner pane and/or the outer pane by laser processes.

The electrical attachment part is thus integrated into the laminated pane in a space-saving and visually inconspicuous manner. Encapsulation of the attachment parts on the surface of the laminated pane is unnecessary. For example, in the automotive sector, visually appealing integration of the various electrical attachment parts situated in the vision portion of a motor vehicle glazing vehicle is desirable. In the context of a striking visual design, modern motor vehicle laminated panes are bent three dimensionally, with an observable trend toward increasingly stronger bends. The laminated pane according to the invention is a vehicle laminated pane with a laser-generated recess. Such a recess has correspondingly high precision and manufacturing tolerance such that it is suitable to accommodate an attachment part of a fixed size with a good fit, even in three-dimensionally bent panes. A recess generated by laser processes can be distinguished from an opening generated by mechanical processes in terms of its surface structure and precision.

In a particularly preferred embodiment of the laminated pane according to the invention, the recess has, at least in sections, an angular contour. In this context, “contour of the recess” refers to the shape of the circumference of the recess in plan view of one of the pane surfaces. In the context of the invention, the term is understood as “non-circular”. A polygonal contour with rounded corners is also considered as an angular contour. An angular contour or a contour with an angular shape in sections is advantageous in terms of a secure fixing of the attachment part. In a circular recess, unwanted rotation of the attachment part is possible. An angular recess prevents this. Particularly preferred are hybrid shapes in which the contour of the recess has round sections in combination with angular, rounded, or elliptical sections. A circular recess can in some cases be more visually appealing, for example, in the case of a light source as interior lighting or a reading lamp. However, in this case, unwanted rotation of the attachment part upon contact with a surface on the outer side of the pane must nevertheless be avoided. For this purpose, the circular recess is expanded by one or a plurality of lateral notches that connect directly to it. Overall, this yields an angular contour of the recess. In addition to the aspects mentioned, other advantages of a non-circular recess are also conceivable. For example, the recess can be optimally adapted with respect to its contour to the shape of the attachment part. Furthermore, recesses adjacent a primary opening can be used for attaching or accommodating electrical connection elements, also yielding an angular contour of the recess.

Such complex recesses are obtainable by laser methods, whereas mechanical methods, such as mechanical drilling do not permit them.

In a preferred embodiment, the recess is implemented in at least one subregion as a through-going opening and in at least one other subregion as a non-through-going partial recess. In the region of the through-going opening, the depth of the recess corresponds to the pane thickness of the inner pane or outer pane into which the recess is introduced. In the region of the non-through-going partial recess, the depth of the recess is less than the thickness of the pane into which the recess is introduced. This is advantageous because, in this way, a subregion of the attachment part can be provided exposed on one of the pane surfaces, while another subregion is enclosed by the pane. The subregion of the recess that is implemented as a non-through-going partial recess thus serves, for example, to accommodate elements protruding beyond the attachment part, such as cables, connection elements, or fastening elements. Preferably, in the region of the partial recess, fastening elements for the attachment part or fastening elements of the attachment part itself can be provided. In a preferred embodiment, fastening elements via which an attachment part that is inserted in the region of the through-going opening is reversibly fixed are provided in the region of the partial non-through-going recess. Thus, the attachment part can be replaced on the exposed surface of the through-going opening. The fastening elements are, for example, clip profiles. The fastening elements can be mounted integrally with the attachment part itself, on a cover of the attachment part, or even as separate elements.

In a preferred embodiment, the inner edge of the recess is sloped, in other words, it forms an angle deviating from 90° with the pane surfaces of the pane into which the recess is introduced. This is advantageous in order to enable reversible replacement of attachment parts, for example, via a flexible rubber ring that is inserted into the sloped region and is removed for exchanging the attachment part. The sloped region can also be used to enlarge the gap between the attachment part and the pane, which serves to accommodate adhesives for bonding the attachment part, and to ensure a secure bond. The angle α between the inner edge of the recess and one of the adjacent pane surfaces is preferably 20° to 80°, particularly preferably from 30° to 70°, in particular from 40° to 60°. It was thus possible to achieve good results.

One embodiment of the invention includes a laminated pane with a through-going hole in the inner pane, wherein the inner edge of the through-going hole is sloped at least in subregions. The inner edge assumes an angle within said region relative to the outer side of the inner pane. This embodiment is advantageous for accommodating fastening elements, such as clip profiles, with which the attachment part can be reversibly removed.

In one possible embodiment, the at least one electrical attachment part is situated entirely within a recess of the inner pane or the outer pane. This is advantageous since only one recess has to be created per attachment part. There can be multiple recesses, each with at least one attachment part.

The electrical attachment part can also optionally protrude, in parts, into the thermoplastic intermediate layer. This is advantageous if an attachment part is introduced on the inner side of the inner pane or of the outer pane and the depth of the attachment part is somewhat greater than the depth of the recess.

In another preferred embodiment of the laminated pane, congruent recesses are provided in the inner pane and the outer pane, with the electrical attachment part inserted into these two congruent recesses and protruding into both recesses. In this case as well, the attachment part is fully integrated within the laminated pane and does not protrude beyond it. This embodiment is particularly advantageous when the dimensions of the attachment part to be integrated are quite large compared to the pane thickness of the inner pane or the outer pane. In this case, two congruent recesses are made to accommodate even larger attachment parts. The attachment part protrudes, in this case, through the thermoplastic intermediate layer.

The inner side of the inner pane of the laminated glass according to the invention (or the laminated pane) is the surface of the inner pane oriented in the direction of the thermoplastic intermediate layer, whereas the outer side of the inner pane is oriented, in the installation position, toward the vehicle interior. The inner side of the outer pane is also oriented toward the thermoplastic intermediate layer, whereas, in contrast, the outer side of the outer pane points toward the external environment. The inner pane and the outer pane contain glass and/or transparent plastics, such as, for example, polycarbonate or polymethyl methacrylate. Preferably, at least the panes into which a recess is introduced are made of glass. Any other panes can be arranged on the outer side of the outer pane or the inner pane and be joined thereto by lamination with interposition of thermoplastic films or even via spacers in the case of an insulating glazing.

The laminated pane according to the invention can also have multiple electrical attachment parts that are introduced within recesses of the inner pane and/or of the outer pane.

The recess in one of the panes of the laminated pane can be implemented either as a through-going opening or as a non-through-going recess of the pane. Here, “through-going opening” refers to a hole that extends from the inner side of a pane to the outer side of the same pane and, thus, completely penetrates the pane. A “non-through-going recess” does not completely penetrate the pane and is only an opening starting from a pane surface (inner side or outer side) that does not extend to the opposite surface of the same pane. Preferably, the recess is a drilled hole. This can have any contour, preferably a circular, elliptical, rectangular, or trapezoidal contour. A through-going opening is primarily used in the inner pane, since, in this case, the outer pane of the laminated pane provides the necessary protection against the effects of weather. Implementation of the recess as a through-going opening in the outer pane is, however, also conceivable, in particular when the laminated pane is integrated into a pane arrangement comprising multiple panes and the necessary protection against environmental influences is guaranteed by another pane of the pane arrangement.

In a first preferred embodiment, the recess is a through-going opening in the inner pane. The through-going opening extends from the outer side of the inner pane to the inner side of the inner pane. Such a design is advantageous, for example, if an electrical supply line is intended to be routed from the inner side of the inner pane out of the laminated pane composite into the recess and the recess is intended to be reversibly accessible from the outer side of the inner pane.

In a second preferred embodiment of the laminated pane, the depth of the recess is less than the thickness of the inner pane or the outer pane into which the recess is introduced. It is thus only a partial recess in which the material of the pane is not penetrated in its full depth by the recess. The recess thus extends from a first pane surface (inner face or outer face) into the interior of the pane, with pane material remaining between the bottom surface of the recess and the second pane surface opposite the recess.

This second preferred embodiment is particularly advantageous in order to seal the recess on a pane surface against the environment. In this case, the recess is, for example, arranged such that the pane material remaining between the bottom of the recess and the opposing pane surface covers the recess toward the environment or toward the thermoplastic intermediate layer. In contrast, a recess in the form of a through-going opening connects the outer side of the pane to the inner side of the pane. This carries the risk of moisture entering from the outer side of the pane through the through-going opening into the interior of the laminate of the laminated pane. In particular, in the case of corrosion-susceptible coatings on the inner side of the pane, corrosion damage in the form of rust spots is immediately distractingly visible. Such corrosion damage can be completely avoided by using the second embodiment according to the invention.

In the production process, when the recess of the laminated pane is arranged per the second embodiment on the inner side of the inner pane or the outer pane, the electrical attachment part is inserted into the recess prior to lamination of the laminated pane. Subsequent processing of the laminated pane is, accordingly, no longer necessary. The two outer sides of the pane remain completely intact, which is not only particularly appealing visually but also provides the greatest possible protection of the attachment part and of the laminate against moisture and environmental influences.

With regard to the depth of the recess, recesses with subregions that are implemented as through-going holes and subregions that are implemented as non-through-going partial recesses are also possible. In the case of these hybrid forms, the depth of the recess is, at least in sections, less than the thickness of the outer pane or the inner pane into which the recess is introduced. Regions with shallower depth can be provided in the form of steps or as sloped regions.

The combination of an inner pane or an outer pane having a through-going opening with an inner pane or an outer pane with an only partial, non-through-going recess is also possible. One example of an application for this would be a laminated pane including an inner pane having a through-going opening and an outer pane having a non-through-going recess on the inner side, wherein the recess of the outer pane is positioned congruent with the through-going opening of the inner pane. In such a laminated pane, the integration of electrical attachment parts with an increased space requirement is also possible.

Particularly in the automotive sector, there has been in recent years a trend toward increasingly lower glass thicknesses, enabling savings in terms of vehicle weight. The pane thicknesses of an automobile glazing, in particular a windshield are, for the inner pane, usually in the range from 0.3 mm to 2.5 mm and, for the outer pane, in the range from 0.8 mm to 2.5 mm. An asymmetric thickness combination, in which the thickness of the outer pane is greater than the thickness of the inner pane, is, especially with a low total thickness, advantageous in terms of improved stability of the laminated pane.

In a preferred embodiment, the laminated pane is a windshield, wherein the thickness of the outer pane is between 1.4 mm and 2.1 mm and the thickness of the inner pane is between 0.8 mm and 1.8 mm.

The thickness of the pane into which the recess is introduced is, for all embodiments mentioned, between 1.0 mm and 50.0 mm, preferably between 1.5 mm and 30.0 mm, particularly preferably between 2.0 mm and 25.0 mm.

When the recess is implemented as a through-going hole, the depth of the recess corresponds to the thickness of the pane into which the recess is introduced.

When the recess is a non-through-going recess, the depth of the recess is defined as the distance between the pane surface, from which the recess starts, and the farthest point of the bottom surface of the recess from this pane surface. The depth of the recess is preferably between 0.8 mm and 15.0 mm, particularly preferably between 1.0 mm and 8.0 mm.

The material thickness of an inner pane or an outer pane with a partial recess remaining in the region of the recess is preferably at least 0.3 mm, particularly preferably at least 0.4 mm. The thickness of the material remaining in the region of the recess also depends on the intended use or the mechanical load on the laminated pane.

In a preferred embodiment of the laminated pane, the at least one electrical attachment part is fully embedded in a recess on the outer side of the inner pane. The electrical attachment part points in the direction of the motor vehicle interior and is protected against road spray and weather influences by the outer pane of the laminated pane. The recess can be through-going in the form of a through-going hole or, also, non-through-going. The electrical attachment part can end flush with the recess in which is embedded such that no gap develops between the attachment part and the surrounding edge of the recess. This is not merely for the purpose of a visually appealing design, but also improves the protection of the attachment part against dirt and road spray. Alternatively, the recess can also be closed with a cover made, for example, of plastic. The design of the cover depends on the specific application. For example, opaque covers are suitable for concealing electrical components, whereas, with the use of a light source radiating in the direction of the interior, a transparent cover is preferred. Depending on the application, the cover can be watertight and irreversibly sealed or even removable. A reversibly sealed opening of the recess toward the motor vehicle interior can also be advantageous with regard to maintenance work on the electrical attachment part.

Particularly preferably, the cover of the attachment part or the attachment part itself has reversible fastening elements, for example, clip profiles, while at least one subregion of the inner edge of the recess is sloped. The fastening elements are provided within the sloped region of the recess and fix the attachment part within the recess. Suitable designs of clip profiles or other reversible fastening elements are known to the person skilled in the art.

In another preferred embodiment of the laminated pane, the electrical attachment part is embedded in a recess on the inner side of the inner pane and/or the inner side of the outer pane. As already mentioned, two congruent recesses can be mounted on the two pane-interior sides. To the extent possible, only one recess is provided on one of the pane-interior sides since this makes the production process substantially simpler than creating two congruent openings.

The electrical attachment part preferably has at least one electrical supply line. This serves to supply power to the component or, if necessary, to transmit data and signals between an electrical attachment part and an external control unit. The electrical supply line is preferably routed between the inner side of the inner pane and the inner side of the outer pane to the recess and is laminated in via the thermoplastic intermediate layer. On one side, the supply line makes electrically conductive contact with the attachment part within the recess; whereas, on the opposite end of the supply line, a voltage source and/or a control unit is contacted. Cable routing within the thermoplastic intermediate layer provides the advantage that the supply line is visually less conspicuous and is protected against mechanical damage, for example, during cleaning of the pane. Alternatively, the power supply of the electrical attachment part can also be provided by a voltage source (e.g., battery) integrated in the recess and the data transmission between an electrical attachment part and a possibly required control unit can be done via wireless transmission platforms (e.g., wireless LAN, Bluetooth, infrared, radio).

To ensure a particularly attractive design, the electrical power supply can also be done via an electrically conductive layer on one of the pane surfaces. A visually distracting electrical supply line in the form of wires can be dispensed with. In motor vehicle window panes, electrically conductive layers are already frequently used in the form of heatable layers or so-called “low E layers” (low emissivity), which prevent strong heating of the motor vehicle interior. Depending on a further intended use of the electrically conductive layer, it can be applied on the inner side of the outer pane, the inner side of the inner pane, or the outer side of the inner pane. Examples of layer structures that have both high electrical conductivity and infrared reflecting action are known to the person skilled in the art from WO 2013/104439 and WO 2013/104438. However, any electrically conductive layer is also suitable for the electrical contacting of the attachment part. Current paths via which the two voltage poles are connected to the electrical attachment part according to the invention are introduced into the electrically conductive layer. Methods for patterning electrically conductive layers are well-known to the person skilled in the art. These include for example, etching or laser methods. Particularly preferably, the current paths are produced by laser separation lines in the electrically conductive layer.

The contacting of an electrical attachment part on a conductive layer can be done, for example, by means of connection elements applied on the electrically conductive layer. When the electrically conductive layer is situated on the inner side of the inner pane or the inner side of the outer pane, a foil-like connection element can be inserted into the layer stack in the region of the recess. This connection element has, on the surface facing the electrically conductive layer, two electrical contacts that are placed on the corresponding current paths of the electrically conductive layer. The surface of the foil-like connection element surrounding the electrical contacts can, for example, be provided with an adhesive that fixes the connection element on the layer. The subregion of the foil-like connection element on which the electrical attachment part is to be placed is also provided with contacts. Preferably, the foil-like connection element has, for this purpose, a metallic surface. The contacting between the attachment part and the foil-like connection element is preferably non-cohesive, i.e., occurs in the form of a detachable connection. Preferably, the attachment part is inserted in a friction-locking manner into the recess, which creates an electrical contact of the attachment part with the metallic surface of the foil-like connection element. Thus, to replace the connection element, only the friction-locked connection (for example, clip profile) has to be released.

The at least one electrical attachment part can comprise any electrically controllable component that is used in the field of automotive glazing and is customarily mounted on an outer surface of the laminated pane. The electrical attachment part is preferably a sensor, a detector, a camera, an antenna, a display, or a light source. The most relevant electrical attachment parts in the vehicle sector include cameras, antennas, rain sensors, light sensors, and light sources in the form of LED lights. The solution according to the invention can also provide results that are very attractive visually in connection with the integration of a display, for example, in a through-going hole in an inner pane of a windshield.

The at least one electrical attachment part has a width and/or a height between 2.0 mm and 100.0 mm, preferably between 5.0 mm and 50.0 mm. The width and the height of the attachment part are defined as the dimensions that run parallel to the pane surfaces of the laminated pane after installation of the attachment part in the recess.

The electrical attachment part is selected such that its depth (thickness) suits the depth of the recess. The depth is defined as the dimension of the attachment part that is oriented perpendicular to the pane surfaces after insertion of the attachment part in the recess. Depending on the available recess depth, even relatively small dimensioned attachment parts can be selected. Usually, the depth of the attachment parts is between 0.5 mm and 15 mm, preferably 1.0 mm to 10 mm, particularly preferably 1.5 mm to 5 mm.

Even multiple attachment parts can be inserted in one recess since the time and thus the cost for creating a larger recess for multiple components is less than that required for creating multiple smaller openings.

The at least one electrical attachment part is preferably inserted into the laminated pane via an adhesion-promoting layer. In one possible embodiment, the electrical attachment part is inserted into the thermoplastic intermediate layer and is laminated in the laminated pane. Another option consists in gluing the electrical attachment part in the recess via an adhesive. Suitable adhesives are well-known to the person skilled in the art, for example, adhesives from the group of polyurethane adhesives. Depending on the design of the recess, the bonding of the attachment part can be done before or after the lamination operation. When the attachment part is glued in before the lamination operation, bonding of the attachment also occurs via the thermoplastic intermediate layer. The adhesion-promoting layer can additionally be used for the electrical connection of the attachment part, with electrically conductive adhesives being used.

Particularly preferably, an electrical attachment part is reversibly fixed in a through-going opening or a partially through-going recess, as a result of which the replacement of the component is simplified. Reversible assembly is possible, for example, using fastening elements such as clip profiles or elastomeric materials such as rubber rings.

Light sources inserted into the laminated pane can be oriented in a wide variety of conceivable directions and, for example, radiate into the interior of the vehicle in which the laminated pane is used as well as in the direction of the environment. Another possibility is coupling the light into the laminated pane via the edge of the recess. The cut edges of the recess are usually matte without further treatment. Therefore, for the targeted coupling of light into the pane, these edges must be polished beforehand. Otherwise, the edges of the recess themselves appear to be luminous since the light is scattered on the matte edge. This can optionally be used for decorative purposes but is usually undesirable.

Another advantage of the integration according to the invention of light sources in a recess of the laminated pane is their flexible positioning. According to the prior art, light sources for coupling light into a pane are mounted on its outer peripheral edge. The angle of incidence and the positioning are bound to the course of the pane edge. Since the recess according to the invention of the inner pane and/or the outer pane is freely selectable in its contour, this also applies to the positioning of the light sources arranged therein. According to the invention, multiple light sources that radiate in various directions can thus be integrated in a very small space.

For coupling light out of the laminated pane, specific regions of higher light scattering are produced in the pane. These can be produced on a pane surface, for example, by engraving, etching, sandblasting, or laser methods such as laser ablation, preferably on the inner side of the inner pane or the outer pane, or in the case of laser methods, within the inner pane or the outer pane. Such methods are well-known to the person skilled in the art.

The recess has, on at least one edge, an edge length or, when the recess approaches the circular shape, a diameter of less than 100 mm, preferably less than 50 mm, particularly preferably less than 20 mm, in particular less than 15 mm. In the case of polygons with three or four corners, the edge length of the recess is defined as the distance between two adjacent corners. In the case of polygons with at least five corners, due to their approaching the circular shape, the diameter is used as the relevant parameter.

Depending on the field of application of the invention, the recess can also have an elongated shape. This is, for example, the case when an LED strip is embedded in a recess of the laminated pane.

The area of the recess is preferably less than 25 cm², particularly preferably less than 10 cm², in particular less than 3 cm². Such small recesses enable integration of the electrical attachment parts that is, visually, particularly inconspicuous.

The contour of the recess visible on the inner side and/or the outer side of the panes preferably has radii of curvature of less than 5 mm, particularly preferably less than or equal to 2 mm. This is particularly advantageous since the recess can thus be adapted in its contour to the dimensions of the attachment part, consequently ensuring the visually inconspicuous integration of the attachment part.

In a particularly preferred embodiment of the invention, a recess is introduced in the inner pane in a vehicle laminated pane, into which recess a light source, for example, an SMD LED is inserted. The recess has a cover that serves at the same time as a lens for scattering the light. Suitable lenses are, for example, Fresnel lenses or TIR lenses (TIR=total internal reflection). Such lenses are commercially available. Polycarbonate (PC), polymethyl methacrylate (PMMA), and silicones have proved to be particularly suitable as materials. The lens includes optionally reversible fastening elements that can be inserted into the recess, for example, in a sloped region of the inner edge. In this manner, the lens can be removed for replacement of the light source. To ensure the easiest possible replacement, the lens can include, on its surface facing the light source, a holder into which the light source is inserted. Thus, when the lens is removed, the light source is removed at the same time and the user can replace it. The electrical contacting of the light source occurs, as already described elsewhere, via a foil-like connection element. This further facilitates the replacement of the light source.

The thermoplastic intermediate layer contains at least one thermoplastic film and is formed, in an advantageous embodiment, by a single thermoplastic film. This is advantageous in terms of a simple structure and a low overall thickness of the laminated glass. The thermoplastic intermediate layer or the thermoplastic film preferably contains at least polyvinyl butyral (PVB), ethylene vinyl acetate (EVA), polyurethane (PU), or mixtures or copolymers or derivatives thereof, which have proven themselves for laminated glass.

The thickness of the thermoplastic intermediate layer is preferably from 0.2 mm to 1.0 mm. For example, thermoplastic films of the standard thickness of 0.76 mm can be used.

The outer pane, the inner pane, and the thermoplastic intermediate layer can be clear and colorless, but also tinted or colored. The total transmittance through the laminated glass is, in a preferred embodiment, greater than 70%, in particular when the laminated glass is a windshield. The term “total transmittance” is based on the process for testing the light permeability of motor vehicle windows specified by ECE-R 43, Annex 3, § 9.1.

The laminated glass is preferably bent in one or in a plurality of spatial directions, as is customary for motor vehicle window panes, with typical radii of curvature in the range from approx. 10 cm to approx. 40 m.

The inner pane and/or the outer pane can be thermally or chemically tempered, partially tempered, or non-tempered.

In an advantageous embodiment of the laminated pane as a windshield of a motor vehicle, the outer pane is a non-tempered pane. The outer pane can be exposed to stresses such as stone impact. If a stone, in particular a small, sharp stone, strikes a glass pane, it can pass through the surface. In the case of a tempered pane, the stone can thus penetrate into the tensile stress zone in the pane interior, resulting in shattering of the pane. A non-tempered outer pane has a wide compressive stress zone and lower tensile stress in the interior and is thus less vulnerable to the impact of a sharp body. A non-tempered outer pane is, consequently, overall, very advantageous in terms of the safety of the vehicle occupants.

In a preferred embodiment of the invention, the outer pane contains soda lime glass or borosilicate glass, in particular soda lime glass. Soda lime glass is economically available and has proved its value for applications in the automotive sector.

The inner pane can, in principle, have any chemical composition known to the person skilled in the art. The inner pane can, for example, contain soda lime glass or borosilicate glass or be made of these glasses.

In an advantageous embodiment of the invention, the inner pane is a chemically tempered pane. Through tempering, the inner pane can be provided with special break stability and scratch resistance. For very thin glass panes, chemical tempering is more suitable than thermal tempering. Since thermal tempering is based on a temperature difference between a surface zone and a core zone, thermal tempering requires a minimum thickness of the glass pane. Adequate stresses can typically be reached with commercially available thermal tempering equipment at glass thicknesses starting from approx. 2.5 mm. With lower glass thicknesses, the values generally required for tempering usually cannot be reached (cf., for example, ECE Regulation 43). In the case of chemical tempering, the chemical composition of the glass in the region of the surface is changed by ion exchange, wherein the ion exchange by diffusion is limited to a surface zone. Chemical tempering is, consequently, particularly suitable for thin panes. Chemical tempering is also commonly referred to as chemical prestressing, chemical hardening, or chemical toughening.

If a chemically tempered glass pane is to be provided with a recess, the pane is first provided with the desired recess and then tempered. This has the advantage that the stress distribution generated by the tempering process is not adversely affected by subsequent machining operations.

In the automotive sector, both the stability and breaking strength of the laminated glass as well as the lowest possible weight of the glazing are of enormous importance. In this regard, it was found that an asymmetry of the outer and the inner pane in terms of their thickness has an advantageous effect on the stability of the laminated pane. The thickness of the outer pane is usually substantially greater than the thickness of the inner pane. Such thickness asymmetry with the associated advantages can also be desirable in the laminated pane according to the invention with an integrated electrical attachment part. In this case, the recess is preferably provided on the inner side of the outer pane, and the electrical attachment part is fully embedded in this recess. The thinner inner pane remains intact in this case and serves only to cover the recess.

In particular in the automotive sector, foil conductors are customarily used as supply lines for contacting in the interior of laminated panes. Examples of foil conductors are described in DE 42 35 063 A1, DE 20 2004 019 286 U1, and DE 93 13 394 U1.

Flexible foil conductors, sometimes also called “flat conductors” or “flat-band conductors”, are preferably made of a tinned copper strip with a thickness from 0.03 mm to 0.1 mm and a width from 2 mm to 16 mm. Copper has proven successful for such conductor tracks since it has good electrical conductivity as well as good processability into foils. At the same time, material costs are low. Other electrically conductive materials that can be processed into foils can also be used. Examples for this are aluminum, gold, silver, or tin and alloys thereof.

The laminated glass can also be provided with an additional function, in that the thermoplastic intermediate layer has functional inclusions, for example, inclusions with IR absorbing, UV absorbing, coloring, or acoustic properties. The inclusions are, for example, organic or inorganic ions, compounds, aggregates, molecules, crystals, pigments, or dyes.

In particular with use of the laminated pane according to the invention in vehicles, for example, as a windshield, it is advantageous to implement further functions in order to reduce the negative effects of weathering influences such as strong solar radiation or ice formation. For this, so-called low-E coatings and/or heatable coatings can be applied to the inner side of the inner pane or of the outer pane. Suitable material compositions of an electrically heatable coating that also functions as a low-E coating can be found, for example, in WO 2013/104439 and WO 2013/104438.

The invention is further accomplished by a method for producing a laminated glass according to the invention, wherein
a) an inner pane or an outer pane is provided,
b) at least one recess is produced in the inner pane and/or the outer pane by laser processes,
c) an electrical attachment part is inserted into the recess,
d) the inner pane per step a) is laminated with an outer pane with interposition of the thermoplastic intermediate layer or the outer pane per step a) is laminated with an inner pane with interposition of the thermoplastic intermediate layer,
   wherein the attachment part is fully embedded in the laminated pane and step c) is done before or after step d).

When the recess is a through-going opening or a partial non-through-going recess adjacent one of the outer sides of the panes, the electrical attachment part is preferably inserted after lamination of the laminated pane. The through-going opening is, in this case, readily accessible even after lamination.

When the recess is non-through-going and is arranged on one of the inner sides of the panes, the electrical attachment part is embedded in the recess prior to lamination of the laminated pane.

The electrical attachment part is glued in the recess using an adhesive and/or laminated in using the thermoplastic intermediate layer. It is also conceivable to fix the attachment part using an adhesive prior to lamination as a result of which it cannot slip during further stacking of the panes. In the subsequent lamination step, the thermoplastic intermediate layer fills the gaps between the attachment part and the walls of the recess.

The recess can be created by a variety of methods for drilling or cutting known to the person skilled in the art.

Preferably, the inner pane and the outer pane of the laminated pane include glass. The recess is introduced into the panes by laser processes. This is particularly advantageous since laser processes can be executed without mechanical processing steps (such as breaking by mechanical pressure). The glass layer is gently cut such that smooth cut edges are formed without disruptive damage. These methods are also well-suited for automated processing.

Moreover, very small radii of curvature of the cut glass layers can be realized. It has been demonstrated that radii of curvature of less than 2 mm can be produced without problems, which is not reliably possible with mechanical processing. The contour of the recess is thus completely freely selectable. Cutting lines with only small mutual spacing can also be realized.

Particularly when using thin glass panes (thickness less than or equal to 1.4 mm) as the inner pane or the outer pane of the laminated pane, laser processing is expedient. Thin glass panes differ from thicker glass panes in their technical processing properties such that conventional mechanical glass cutting methods are often unsuitable. Depending on the thickness of the glass pane, cutting results in a rough cut edge with microcracks and other damage. Subsequent edge processing, as is customary with thicker glass panes, is increasingly difficult with increasing pane thickness. In this regard, laser cutting methods yield a better result and can also be used regardless of the pane thickness.

Recesses in the form of through-going openings are preferably produced by laser drilling. For laser drilling of workpieces, pulsed lasers are primarily used, with workpiece and laser moved relative to one another such that multiple successive pulses strike the same point on the workpiece and the material of the workpiece is melted and vaporized. Through-going openings produced by laser drilling have high geometric precision. Conical openings can also be produced in a simple manner by laser drilling.

Through-going openings of the outer pane and/or the inner pane are preferably implemented as conical openings. This has the advantage that when selecting the suitable conicity, the portion of the pane to be removed drops out of the through-going opening through the effect of gravity. This yields an advantageous slope of the inner edge of the recess, which can, for example, be used to accommodate adhesives or fastening elements. The helical drilling method is, in particular, suitable for producing a conical drilled opening. Here, the laser beam is focused through a first pane surface onto a point of the opposing second pane surface and moved from there along the contour of the through-going opening in the direction of the first pane surface. The through-going opening preferably corresponds in its shape to a truncated cone or a truncated pyramid, with the base surface of the truncated cone or truncated pyramid positioned on the second pane surface and the top surface on the first pane surface.

In a preferred embodiment of the method according to the invention, at least one through-going opening is produced by laser drilling using a pulsed laser. As already described, during laser drilling, the laser beam penetrates the pane to be processed. Accordingly, a wavelength of the laser radiation is selected at which the glass layer is substantially transparent. The glass layer preferably has, at the laser wavelength used, transmittance of at least 80%, particularly preferably at least 90%. For customary glass layers, a laser in the visible, near UV, or IR range can be used, for example, in the range from 300 nm to 2500 nm, preferably from 300 nm to 1100 nm, particularly preferably from 300 nm to 800 nm. In a particularly advantageous embodiment, the laser beam has a wavelength of 400 nm to 600 nm, preferably from 500 nm to 550 nm, for example, 532 nm. This is, on the one hand, advantageous in terms of the transparency of customary glass layers and, on the other, in terms of commercial availability of suitable, economical laser systems. The laser beam is preferably generated by a solid-state Q-switch laser.

The repetition rate (pulse frequency) of the laser beam during helical drilling is preferably from 10 kHz to 1 MHz, particularly preferably from 20 kHz to 500 kHz Hz, for example, 25 kHz or 100 kHz. This yields good results. In principle, however, significantly higher pulse frequencies can be used, for example, up to 100 MHz.

The power of the laser for generating the laser beam during helical drilling is preferably from 5 W to 200 W, particularly preferably from 20 W to 100 W. The pulse energy is preferably from 4 μJ to 500 μJ, for example, 300 μJ.

The speed of movement of the laser beam along the cutting line (contour of the through-going opening) is preferably from 50 mm/s to 5000 mm/s, for example, 4000 mm/s.

The laser beam is preferably focused on the glass surface by means of an optical element or system. The extent of the focus perpendicular to the beam direction can be less than or equal to 50 μm, preferably less than or equal to 30 μm, for example, 10 μm or even less.

In another preferred embodiment of the method according to the invention, the recess is produced by laser ablation using a pulsed laser. For laser ablation, area-wise removal of the material is necessary, which entails increased effort compared to laser drilling. Thus, the ablation method is primarily used to generate non-through-going recesses, since in this case, laser drilling cannot be used.

For area-wise ablation of customary glass layers, a laser in the visible, near UV, or IR range can also be used, for example, in the range from 300 nm to 2500 nm, preferably from 300 nm to 1100 nm, particularly preferably from 300 nm to 800 nm. In a particularly advantageous embodiment, the laser beam has a wavelength from 400 nm to 600 nm, preferably from 500 nm to 550 nm, for example, 532 nm. On the one hand, this is advantageous in terms of the transparency of customary glass layers and, on the other, in terms of the commercial availability of suitable, economical laser systems. The laser beam is preferably generated by a Q-switched solid-state laser.

The repetition rate (pulse frequency), speed of the laser beam, and the power of the laser beam for laser ablation are within the ranges mentioned for the laser drilling method.

The pulse length for both laser drilling and laser ablation is preferably less than 10 ns, particularly preferably less than 1 ns, for example, 1 ps.

The surface roughness of the cut edges or the bottom surface of the recess can be specifically influenced by modification of the laser parameters. In general, it can be noted that the transparency of the surfaces increases with decreasing laser power.

The laser beam is preferably focused on the glass surface by means of an optical element or system. The extent of the focus perpendicular to the beam direction can be less than or equal to 50 μm, preferably less than or equal to 30 μm, for example, 10 μm or even less.

Optionally, the edges and/or the bottom surface of the recess can be polished. Particularly with low glass thicknesses, the use of laser methods here is advantageous because direct contact with the glass surface and resultant damage are avoided. The laser radiation for polishing the edges of the recess has, for example, a wavelength from 800 nm to 20 μm, preferably from 1 μm to 20 μm, particularly preferably from 5 μm to 15 μm. A continuous CO₂ laser is particularly suitable, typically with a wavelength of 9.4 μm or 10.6 μm.

In another embodiment of the method according to the invention, the recess is produced by means of a two-stage laser method. In a first step, material modifications, so-called filaments, are produced in the pane by means of a first laser with a pulse length of less than 100 ps and a wavelength of 300 nm to 800 nm. In a second step, heating is done with a second laser in continuous wave operation with a wavelength of 1 μm to 20 μm. In a third step, the pane is cooled, as a result of which the glass pane breaks along the line of the material modification and yields the desired recess. A suitable method is described, for example, in WO 2017 025550 A1.

In all laser processes described here, the movement of the laser beam along the cutting line can, in principle, be done by movement of the panes and/or by movement of the laser radiation. For movement of the laser beams over a pane (in particular, a stationary pane), laser scanning devices known per se are suitable, in the simplest case, one or a plurality of tilting mirrors. The laser radiation can also be moved, for example, by moving an optical waveguide, for example, a glass fiber over the glass surface. However, it can be easier and, consequently, preferable to leave the laser beam stationary and only move the pane.

At least the outer pane of the laminated glass is subjected to a bending process prior to lamination. In a preferred embodiment, the inner pane is also subjected to a bending process. This is advantageous, in particular in the case of strong bends in multiple spatial directions (so-called three-dimensional bends).

Alternatively, the inner pane is not pre-bent. This is particularly advantageous in the case of inner panes with very low thicknesses since they have film-like flexibility and can thus be adapted to the pre-bent outer pane without having to be pre-bent themselves.

The outer pane and the inner pane can be bent individually. Preferably, the outer pane and the inner pane are bent congruently together (i.e., simultaneously and by the same tool), because, as a result, the shape of the panes is optimally matched to one another for the subsequent lamination.

The bending of the panes is preferably done prior to the laser processing. If an electrically conductive layer is to be applied to the panes, it is deposited on the desired pane surfaces prior to the bending. For example, the inner pane and/or the outer pane are first provided with an electrically conductive layer, for example, by magnetron sputtering. In a next step, the inner pane and the outer pane are bent congruently together and prepared per step a). Only after that is the laser processing done per step b). Since the panes have already reached their final bend, a 3D laser process is used. This has the advantage that the recess can be produced in its final dimensions and an effect of the bending process on the recess does not have to be taken into account. In this manner, production tolerances can be maintained significantly more precisely. The laser patterning of an electrically conductive layer for generating current paths is also done after the bending of the panes and thus also in the form of a 3D laser process. This is advantageous, since the electrically conductive layer is removed in the region of the laser patterning and, thus, there is a different heat distribution in this region. This can cause optically visible damage.

The thermoplastic intermediate layer is preferably provided as a film. The production of the laminated glass by lamination is done with conventional methods known per se to the person skilled in the art, for example, autoclave methods, vacuum bag methods, vacuum ring methods, calendar methods, vacuum laminators, or combinations thereof. The bonding of the outer pane and the inner pane is customarily done under the effect of heat, vacuum, and/or pressure.

The invention further includes the use of the laminated pane according to the invention with an electrical attachment part integrated in a recess as a vehicle glazing, in particular a windshield, roof panel, side window, or rear window.

The invention is explained in detail with reference to drawings and exemplary embodiments. The drawings are schematic representations and not to scale. The drawings in no way restrict the invention. They depict:

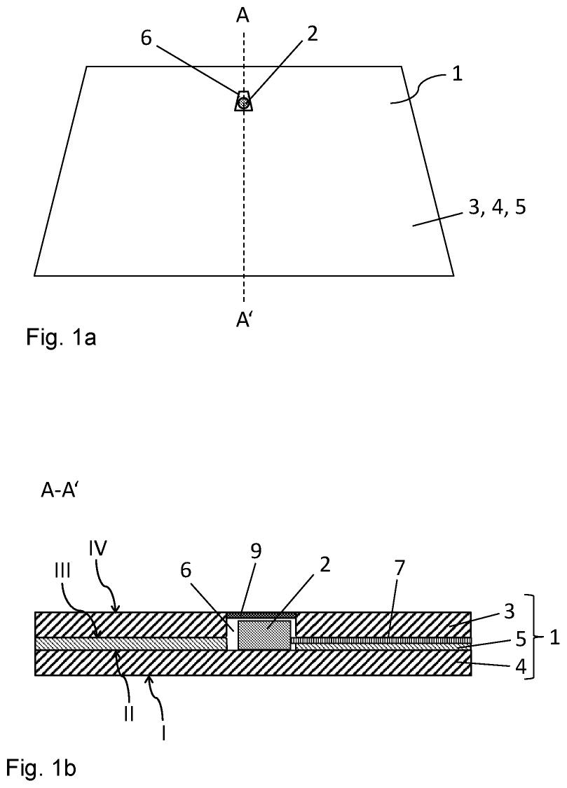

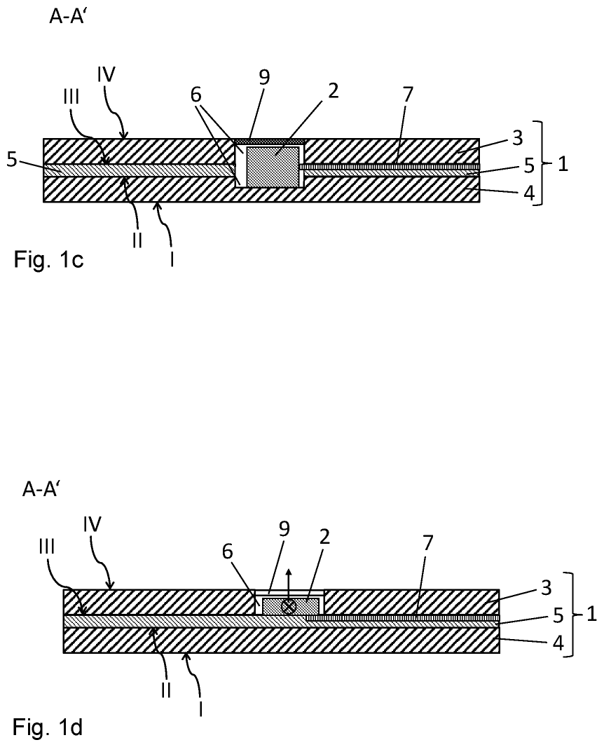

FIG. 1 a plan view and multiple cross-sections of various embodiments of the laminated pane according to the invention with at least one recess in the form of a through-going hole,

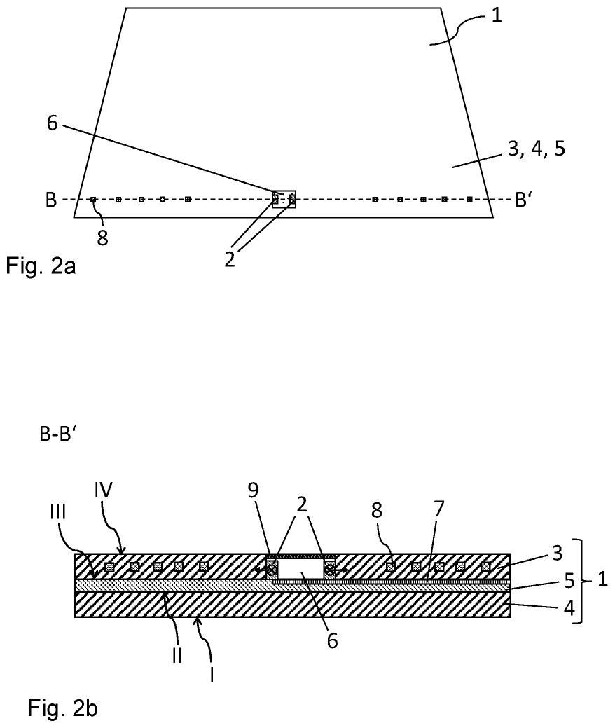

FIG. 2 a plan view and a cross-section of another laminated pane according to the invention with a recess in the form of a through-going hole with inserted light sources, wherein the light sources are arranged on the edge of the recess,

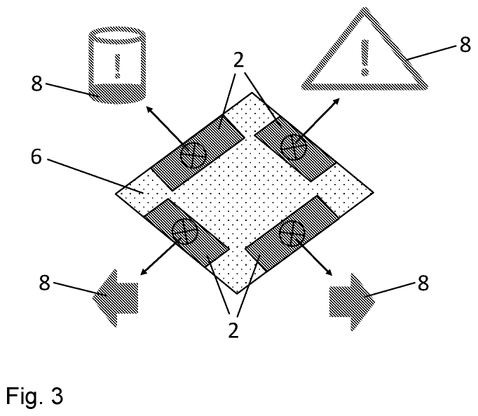

FIG. 3 a plan view of a detail of another laminated pane according to the invention with recess with inserted light sources, wherein the light sources illuminate various symbols in the pane,

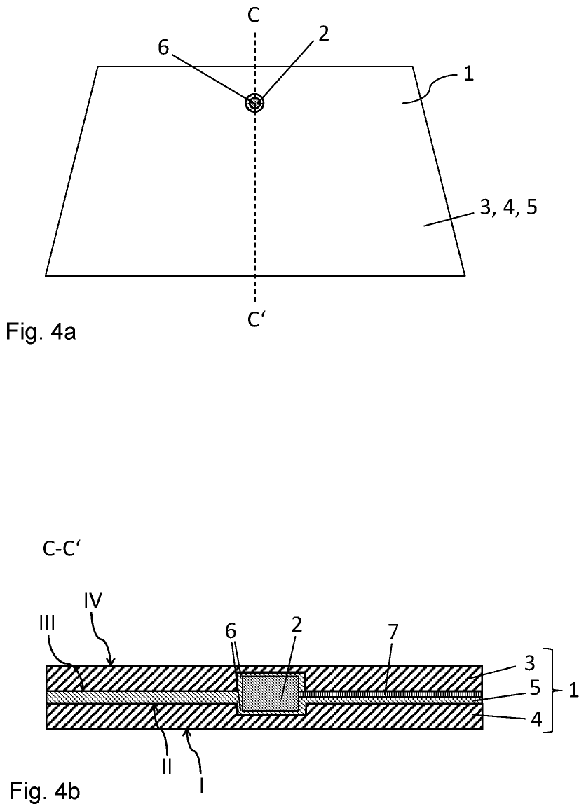

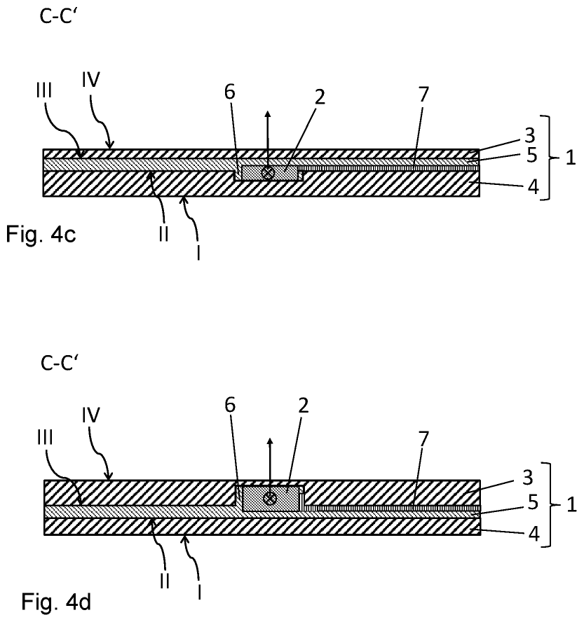

FIG. 4 a plan view and multiple cross-sections of various embodiments of the laminated pane according to the invention with partial, non-through-going, recesses,

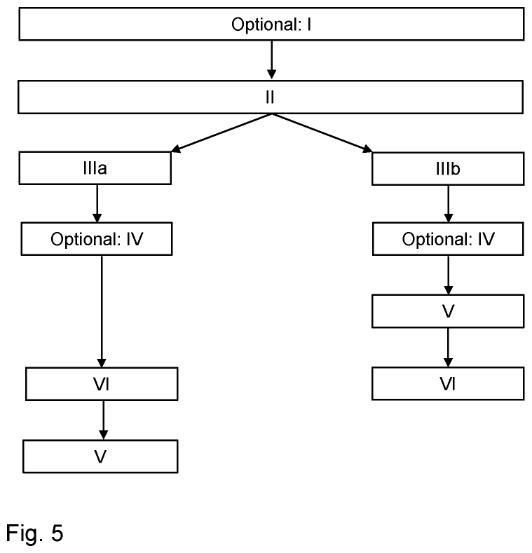

FIG. 5 an embodiment of the method according to the invention.

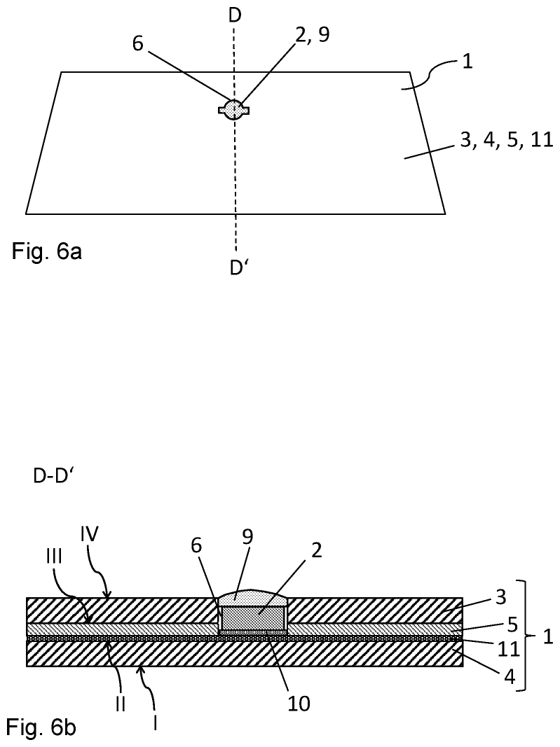

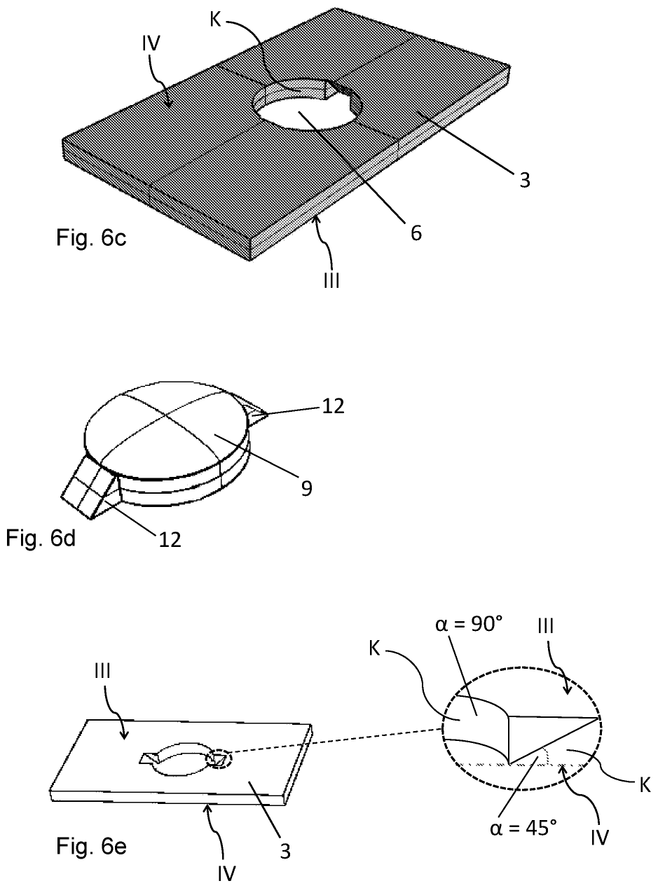

FIG. 6 an embodiment and multiple detailed views of a laminated pane according to the invention as a roof panel of a motor vehicle with inserted light source and lens.

FIG. 1a, 1b, 1c, and 1d depict a plan view and multiple cross-sections of various embodiments of the laminated pane according to the invention with at least one recess in the form of a through-going hole, in which an electrical attachment part is integrated. FIG. 1a depicts a plan view of the laminated pane 1 comprising an inner pane 3 and an outer pane 4 that are laminated together via a thermoplastic intermediate layer 5. The inner pane 3 has an outer surface IV and an inner surface III. The outer pane has an inner surface II and an outer surface I. The thermoplastic intermediate layer 5 joins the inner surface III of the inner pane 3 and the inner surface II of the outer pane 4. The laminated pane 1 is used as a windshield of a motor vehicle. The outer pane 4 and the inner pane 3 are made of soda lime glass. The thermoplastic intermediate layer 5 is a polyvinyl butyral film with a thickness of 0.76 mm measured prior to the lamination operation. The laminated pane 1 has a recess 6 in which an electrical attachment part 2 is embedded. FIGS. 1b, 1c, and 1d depict various embodiment variants of the basic structure of FIG. 1a in detail. Possible covers 9 or electrical supply lines 7 are not depicted in FIG. 1a, for simplification. The contour of the recess 6 corresponds to an isosceles trapezoidal shape, wherein the base and the legs of the trapezoid have a length of 1.5 cm and the side of the trapezoid opposite the base has a length of 0.7 cm.

FIG. 1b depicts a cross-section of the basic structure of FIG. 1a along the cutting line AA′. The outer pane 4 and the inner pane 3 have a thickness of 2.1 mm. The inner pane 3 has a recess 6 in the form of a through-going hole. The recess 6 thus extends continuously from the outer side IV of the inner pane 3 all the way to the inner side III of the inner pane 3. An electrical attachment part 2 is embedded in the recess 6, wherein the attachment part 2 is fully integrated into the laminated pane and does not protrude beyond it in any dimension. The attachment part 2 is situated within the recess 6 and protrudes through an opening in the thermoplastic intermediate layer 5 all the way to the inner surface II of the outer pane 4. In the present exemplary embodiment, the electrical attachment part 2 is a camera with a thickness of approx. 2 mm, which was inserted into the recess 6 after lamination of the laminated pane 1. Optionally, the thermoplastic intermediate layer 5 can be removed before or after lamination, in this exemplary embodiment before lamination, in the region of the recess 6. An electrical supply line 7 of the camera is routed to the recess 6 within the thermoplastic intermediate layer 5 of the laminated pane 1. The recess 6 was created by laser drilling before the stacking of the panes and before lamination of the laminated pane 1. The cover 9 is an opaque molded plastic part that reversibly closes the recess 6 on the inner side IV of the inner pane 3. This embodiment is particularly advantageous since the electrical attachment part 2 is integrated into the laminated pane 1 in a visually appealing and inconspicuous manner and is nevertheless reversibly accessible.

FIG. 1c depicts a cross-section of the basic structure of FIG. 1a along the cutting line AA′, wherein the structure corresponds substantially to FIG. 1b. In contrast to FIG. 1b, in addition to a recess 6 of the inner pane as a through-going hole, there is also a partial recess 6 in the outer pane 4. The outer pane 4 has a thickness of 2.1 mm, while the thickness of the inner pane is 1.8 mm. The partial, non-through-going recess 6 of the outer pane 4 is introduced on the inner side II of the pane by laser ablation. All recesses are created before the stacking and lamination of the pane arrangement. The thermoplastic intermediate layer 5 has been removed in the region of the recess 6 before lamination of the laminated pane 1. The electrical attachment part 2, here, a camera, has a thickness of approx. 2.5 mm. This embodiment is advantageous when an electrical attachment part 2, whose thickness exceeds the thickness of the inner pane 3, is to be inserted reversibly.

FIG. 1d depicts a cross-section of the basic structure of FIG. 1a along the cutting line AA′, wherein the structure corresponds substantially to FIG. 1b. In contrast to FIG. 1b, the electrical attachment part 2 is a light source, here, an LED light. The beam direction of the LED is represented in FIG. 1d by an arrow that points in the direction of the vehicle interior. The cover 9 is a transparent plastic and/or glass cover including a lens arrangement that bundles the light of the inserted LED. The thickness of the inner pane 3 and of the outer pane 4 is in each case 2.1 mm, while the LED light has a thickness of 1.5 mm. The thermoplastic intermediate layer 5 has not been removed in the region of the recess 6. This embodiment is particularly advantageous when a light source that requires additional optics is to be reversibly integrated into the laminated pane.

FIGS. 2a and 2b depict a plan view and a cross-section of another laminated pane according to the invention 1 with a recess 6 in the form of a through-going hole with two electrical attachment parts inserted therein. The attachment parts 2 are light sources in the form of LED lights that are arranged on the edge of the recess 6. The laminated pane 1 comprises an inner pane 3 and an outer pane 4 that are laminated together via a thermoplastic intermediate layer 5. The inner pane 3 has an outer surface IV and an inner surface III. The outer pane has an inner surface II and an outer surface I. The thermoplastic intermediate layer 5 joins the inner surface III of the inner pane 3 and the inner surface II of the outer pane 4. The outer pane 4 and the inner pane 3 are made of soda lime glass. The thermoplastic intermediate layer 5 is a polyvinyl butyral film with a thickness of 0.76 mm measured prior to the lamination operation. The electrical attachment parts 2 are fully integrated into the inner pane 3 of the laminated pane 1 and do not protrude beyond the laminated pane 1. An electrical supply line 7 of the attachment parts 2 is routed to the recess 6 within the thermoplastic intermediate layer 5 of the laminated pane 1. The recess 6 was created by laser drilling before the stacking of the panes and before lamination of the laminated pane 1. The cover 9 is an opaque molded plastic part that reversibly closes the recess 6 on the inner side IV of the inner pane 3 and optically conceals the components situated therein. The LED lights are oriented within the recess 6 such that the emitted light is coupled into the inner pane 3 of the laminated pane 1 at the edge of the recess. Multiple patterns 8 are introduced within the inner pane 3, likewise by laser methods. The light coupled in at the recess 6 is coupled out at these locations, by which means the patterns light in the light color of the coupled-in light. Optionally, a switch that enables turning the illumination on and off can be introduced into the cover 9. The recess 6 was created by laser drilling before lamination of the laminated pane 1 and the edge of the recess 6 was polished by laser radiation. The contour of the recess 6 corresponds to a rectangle with edge lengths of 2.0 cm and 1.0 cm. The inner pane with a through-going opening has a thickness of 6 mm; the outer pane has a thickness of 4 mm. The electrical attachment parts 2 have a height of 4 mm measured along the edge of the recess 6. The laminated pane of FIGS. 2a and 2b proves to be particularly advantageous as a component of indoor or outdoor architectural glazing. However, analogous arrangements can also be implemented with the pane thicknesses customary in the automotive sector in curved motor vehicle laminated panes.

FIG. 3 depicts a detailed of another laminated pane according to the invention 1 with electrical attachment parts 2 in the form of LED lights inserted in a recess 6. These light sources illuminate various symbols of a pane. The laminated pane itself is not depicted here, but corresponds in its basic structure substantially to FIG. 1a. The design of the recess 6 can be implemented, as described by way of example in FIGS. 1, 2, and 4, as a through-going opening and/or as a non-through-going opening. The electrical attachment parts 2 are, also in this case, fully integrated into the laminated pane and do not protrude beyond this. The contour of the recess of FIG. 3 is diamond-shaped, with a light source mounted on each edge of the diamond, which illuminates, as needed, a symbol introduced in the vicinity of the recess (pattern 8). Thus, multiple light sources can be introduced into the laminated pane in the smallest space. The positioning and orientation of the light sources is advantageously not dependent on the course of the edge of the laminated pane; for example, the corners of the diamond-shaped recess can be oriented in the direction of the edges of the laminated pane.

FIGS. 4a, 4b, 4c, and 4d depict a plan view and multiple cross-sections of various embodiments of the laminated pane according to the invention 1 with at least one partial recess 6 in the form of a non-through-going hole, in which an electrical attachment part 2 is integrated. The exemplary embodiments of FIG. 4 refer to windshields of the motor vehicle. FIG. 4a depicts a plan view of the laminated pane 1 comprising an inner pane 3 and an outer pane 4 that are laminated together via a thermoplastic intermediate layer 5. The inner pane 3 has an outer surface IV and an inner surface III. The outer pane has an inner surface II and an outer surface I. The thermoplastic intermediate layer 5 joins the inner surface III of the inner pane 3 and the inner surface II of the outer pane 4. The laminated pane 1 is used as a windshield of a motor vehicle. The outer pane 4 and the inner pane 3 are made of soda lime glass. The thermoplastic intermediate layer 5 is a polyvinyl butyral film with a thickness of 0.76 mm measured prior to the lamination operation. The laminated pane 1 has a recess 6 in which an electrical attachment part 2 is embedded. FIGS. 4b, 4c, and 4d depict various embodiment variants of the basic structure of FIG. 4a in detail. Electrical supply lines 7 are not depicted in FIG. 4a, for simplification. The contour of the recess 6 corresponds to a circular hole with a diameter of 1.5 cm.

FIG. 4b depicts a cross-section of the basic structure of FIG. 4a along the cutting line CC′. The outer pane 4 has a thickness of 2.1 mm, and the inner pane 3 has a thickness of 0.8 mm. In addition to a partial recess 6 of the inner pane 3, there is also another partial recess 6 of the outer pane 4. The recess of the outer pane 4 has a depth of 1.0 mm, while the recess of the inner pane 3 has a depth of 0.5 mm. An electrical attachment part 2 is embedded in the recesses 6, with the attachment part 2 fully integrated into the laminated pane 1 and not protruding beyond it in any dimension. The attachment part 2 is situated within the recess 6 and protrudes through the thermoplastic intermediate layer 5 into the partial recess 6 of the outer pane 4. In the present exemplary embodiment, the electrical attachment part 2 is a light sensor with a thickness of approx. 1.5 mm that was inserted into the recess 6 prior to lamination of the laminated pane 1. The thermoplastic intermediate layer 5 begins to flow during the lamination operation and fills the region of the recess 6 that is not occupied by the electrical attachment part 2. An electrical supply line 7 of the camera is routed, within the thermoplastic intermediate layer 5 of the laminated pane 1, to the recess 6 and is likewise inserted into the laminate prior to lamination of the pane arrangement. The recesses 6 were created by laser ablation before the stacking of the panes and before lamination of the laminated pane 1.

The embodiment of FIG. 4b is particularly advantageous in terms of seamless integration of attachment parts in which the outer surfaces of the laminated pane are not damaged.

FIGS. 4c and 4d and depict different examples of the integration of LED lights as electrical attachment parts 2 in a laminated pane 1. The radiation direction of the LED lights can be oriented both in the direction of the vehicle interior and in the direction of the surroundings. The electrical attachment part 2 in the form of an LED light is embedded in the recess such that the attachment part 2 is fully integrated into the laminated pane 1 and protrudes beyond it in no dimension. In the present exemplary embodiments, the electrical attachment part 2 is LED lights with a thickness of approx. 1.5 mm that were inserted into the recesses 6 prior to lamination of the laminated pane 1. The thermoplastic intermediate layer 5 begins to flow during the lamination operation and fills the region of the recesses 6 that is not occupied by the electrical attachment parts 2. An electrical supply line 7 of the light sources is routed, within the thermoplastic intermediate layer 5 of the laminated pane 1, to the recess 6 and is likewise inserted into the laminate prior to lamination of the pane arrangement. The recesses 6 were created by laser ablation before the stacking of the panes and before lamination of the laminated pane 1.

The embodiment of FIG. 4c has an outer pane with a thickness of 2.1 mm and an inner pane 3 with a thickness of 0.4 mm. The outer pane 4 has on its inner side II a partial recess 6 with a depth of 1.2 mm. The LED light is embedded in this recess 6 and protrudes out of the recess 6 into the thermoplastic intermediate layer 5. The LED light shines through the thermoplastic intermediate layer 5 and the inner pane 3 in the direction of the vehicle interior. FIG. 4c illustrates a laminated pane 1 according to the invention with a highly asymmetrical thickness combination of the inner pane 3 and the outer pane 4.

FIG. 4d depicts a laminated pane 1 according to the invention with a partial recess 6 in the inner pane 3. The outer pane 4 has a thickness of 1.4 mm, while the inner pane 3 has a thickness of 1.8 mm. The inner pane 3 has, on its inner side III, a partial recess 6 with a depth of 1.1 mm. An LED light (electrical attachment part 2) with a thickness of 1.3 mm is embedded in this recess 6 and protrudes out of the recess 6 into the thermoplastic intermediate layer 5. The LED light shines through the material of the inner pane 3 remaining in the region of the recess 6 in the direction of the vehicle interior. After laser ablation of the recess 6 in the inner pane 3, the region of the recess 6, through which the light of the LED light passes, is polished by laser processes. Only after that is the LED light inserted into the recess 6 and the pane arrangement laminated.

FIG. 5 depicts an embodiment of the method according to the invention comprising the steps:
I Optional: Joint congruent bending of the outer pane 4 and the inner pane 3,
II Providing the inner pane 3 or the outer pane 4,
IIIa Creating at least one through-going recess 6 in the inner pane 3 and/or the outer pane 4 by laser drilling or
Creating at least one non-through-going partial recess 6 on the outer side IV of the inner pane 3 and/or the outer side I of the outer pane 4 by laser ablation,
IIIb Creating at least one non-through-going partial recess 6 on the inner side III of the inner pane 3 and/or der inner side II of the outer pane 4 by laser ablation,
IV Optional: Polishing the edges and/or bottom surface of the recess 6 by laser processes
V Inserting an electrical attachment part 2 in the recess 6,
VI Laminating a laminated pane 1 formed from the inner pane 3 and the outer pane 4 with interposition of the thermoplastic intermediate layer 5.

If the recess 6 is still accessible after lamination of the laminated pane 1 in step VI (through-going hole or partial recess on the outer side), the electrical attachment part 2 is inserted into the laminated pane after lamination (step V through step VI). If, after lamination of the laminated pane, the recess is fully enclosed thereby and is no longer accessible, the electrical attachment part 2 is inserted into the recess 6 before lamination.

FIGS. 6a, 6b, 6c, 6d, and 6e depict a plan view, a cross-section, and several detailed views of an embodiment of the laminated pane according to the invention with at least one recess 6 in the form of a through-going hole, in which an electrical attachment part 2 is integrated. FIG. 6a depicts a plan view of the laminated pane 1 comprising an inner pane 3 and an outer pane 4 that are laminated together via a thermoplastic intermediate layer 5. The inner pane 3 has an outer surface IV and an inner surface III. The outer pane has an inner surface II and an outer surface I. The thermoplastic intermediate layer 5 joins the inner surface III of the inner pane 3 and the inner surface II of the outer pane 4. The laminated pane 1 is used as a roof panel of a motor vehicle. The outer pane 4 and the inner pane 3 are made of soda lime glass, with the outer pane 4 tinted gray. The thermoplastic intermediate layer 5 is a polyvinyl butyral film with a thickness of 0.76 mm measured prior to the lamination operation. The laminated pane 1 has a recess 6 in which an electrical attachment part 2 is embedded. The electrical attachment part 2 is a light source in the form of a SMD LED, used for the interior lighting of the vehicle. The recess 6 has a circular through-going hole, to which two angular regions with a partial recess are connected in the form of a sloped inner edge K. The inner side II of the outer pane 4 is equipped with an electrically conductive layer 11. The electrically conductive layer 11 is used for window heating, but simultaneously for electrically contacting the electrical attachment parts 2. For this, laser patterning (not shown) is introduced into the electrically conductive layer 11 to create corresponding current paths for connecting the attachment part 2. FIG. 6b depicts a cross-section through the embodiment of FIG. 6a along the cutting line DD′. The recess 6 is closed on the inner side IV of the inner pane 3 by a cover 9 in the form of a TIR. The lens scatters the light of the SMD LED such that the interior of the vehicle is satisfactorily illuminated. The electrical attachment part 2 is mounted directly on the lens such that the lens and the light source can be removed together from the vehicle-interior side. The electrical attachment part 2 is contacted via a foil-like connection element 10 to the current paths introduced into the electrically conductive layer 11. The foil-like connection element 10 has electrical contacts and a bonding surface on the surface facing the electrically conductive layer 11. The surface of the foil-like connection element 10 facing the light source has a metallic layer via which the electrical contacting with the LED occurs. The LED and foil-like connection element 10 are not connected materially to one another such that the light source can be easily replaced. Direct contact of an electrical attachment part 2 and a foil-like connection element 10 suffices for electrical contacting. Electrical attachment parts, in particular LED light sources, that enable such areal contacting are sufficiently well-known. The arrangement comprising an electrical attachment part 2 and the cover 9 implemented as a lens is reversibly fixed in the recess by fastening elements 12. FIGS. 6c and 6e depict the inner pane 3 with a recess 6 of the laminated pane of FIGS. 6a and 6b in detail. FIG. 6d depicts the cover 9 inserted in the recess 6 in the form of a lens in detail. Fastening elements 12 are molded onto the cover 9 in the form of clip profiles. These are reversibly inserted into the part of the recess 6 that has a sloped inner edge K. FIG. 6e depicts a detailed view of the inner edge K of the recess 6. The circular section of the recess 6, which is implemented in the form of a through-going hole, has an angle of 90° between the inner edge K and the inner side IV of the inner pane 3. The inner side IV is depicted in the detailed view of FIG. 6e as a dashed auxiliary line. In the region of the recess 6, in which the inner edge K is sloped, the inner edge K and the inner side IV have an angle of 45° relative to one another. This section of the recess serves for the precise accommodation of the fastening elements 12. In this manner, the cover 9 including the electronic attachment part 2 can be conveniently and reversibly inserted into the roof panel. Such complex recesses are only achievable via laser methods.

### LIST OF REFERENCE CHARACTERS

(1) laminated pane

(2) electrical attachment part

(3) inner pane

(4) outer pane

(5) thermoplastic intermediate layer

(6) recess

(7) electrical supply line

(8) patterning

(9) cover

(10) foil-like connection element

(11) electrically conductive layer

(12) fastening elements

AA′, BB′, CC′, DD′ section lines

K inner edge of the recess 6

α angle between outer side of the pane and inner edge of the recess 6

I outer side of the outer pane 4

II inner side of the outer pane 4

III inner side of the inner pane 3

IV outer side of the inner pane 3

1. A laminated pane having at least one integrated electrical attachment part comprising:
an inner pane having an inner side and an outer side,
an outer pane having an inner side and an outer side,
a thermoplastic intermediate layer, which joins the inner side of the outer pane and the inner side of the inner pane to one another, and
at least one recess of the inner pane and/or of the outer pane,
wherein the electrical attachment part is inserted into the recess and is situated completely within the laminated pane,
the laminated pane is a vehicle laminated pane having a three-dimensional bend, and the recess is introduced into the inner pane and/or the outer pane by laser processes.

2. The laminated pane according to claim 1, wherein the recess has an angular contour, at least in sections.

3. The laminated pane according to claim 1, wherein the recess is implemented as a through-going opening in at least one subregion and as a non-through-going partial recess in at least one other subregion.

4. The laminated pane according to claim 3, wherein the subregion of the recess that is implemented as a non-through-going partial recess serves to accommodate fastening elements.

5. The laminated pane according to claim 1, wherein the inner edge of the recess is sloped and assumes an angle α of 20° to 80° relative to an adjacent pane surface.

6. The laminated pane according to claim 1, wherein the depth of the at least one recess is less, at least in sections, than the thickness of the inner pane or the outer pane in which the recess is introduced.

7. The laminated pane according to claim 6, wherein the thickness of the inner pane or the outer pane in which the recess is introduced is between 1.5 mm and 30.0 mm, and the depth of the recess is between 0.8 mm and 15.0 mm.

8. The laminated pane according to claim 1, wherein the at least one electrical attachment part is mounted in a recess on the outer side of the inner pane.

9. The laminated pane according to claim 8, wherein the at least one electrical attachment part or a cover of the attachment part is reversibly attached in a sloped region of the inner edge of the recess.

10. The laminated pane according to claim 1, wherein the at least one electrical attachment part is mounted in a recess on the inner side of the inner pane and/or the inner side of the outer pane.

11. The laminated pane according to claim 1, wherein the at least one electrical attachment part has at least one electrical supply line, which runs in the thermoplastic intermediate layer between the inner side of the inner pane and the inner side of the outer pane.

12. The laminated pane according to claim 1, wherein the at least one electrical attachment part is electrically conductively contacted via an electrically conductive layer on the inner side of the outer pane, the inner side of the inner pane, and/or the outer side of the inner pane.

13. The laminated pane according to claim 1, wherein the at least one electrical attachment part is a sensor, a detector, a camera, a display, or a light source.

14. The laminated pane according to claim 1, wherein the recess has a diameter of less than 100 mm, or has at least one edge with an edge length of less than 100 mm.

15. A method for producing a laminated pane according to claim 1, the method comprising
a) providing an inner pane or an outer pane,
b) producing at least one recess in the inner pane and/or the outer pane by laser processes,
c) inserting an electrical attachment part into the recess,
d) laminating the inner pane per step a) with an outer pane with interposition of the thermoplastic intermediate layer or laminating the outer pane per step a) with an inner pane with interposition of the thermoplastic intermediate layer,
wherein the attachment part is fully embedded in the laminated pane and step c) is done before or after step d).

16. The method according to claim 15, wherein in step b), the recess is a through-going opening that is produced by laser drilling using a pulsed laser with a pulse length of less than 10 ns, a wavelength of 300 nm to 800 nm, and a power of 5 W to 100 W.

17. The method according to claim 15, wherein the recess is produced by laser ablation using a pulsed laser with a pulse length of less than 10 ns, a wavelength of 300 nm to 800 nm, and a power of 5 W to 100 W.

18. The method according to claim 15, wherein the recess is produced by a multistage laser method, comprising a first step for producing filaments using a first pulsed laser with a pulse length of less than 100 ps and a wavelength of 300 nm to 800 nm, a second step for heating the pane using a second laser in continuous wave operation with a wavelength of 1 μm to 20 μm and a third step in which the pane is cooled.

19. A method comprising utilizing a laminated pane according to claim 1 as a vehicle glazing.

20. The method according to claim 19, wherein the vehicle glazing is a windshield, roof panel, side window, or rear window.
